(19) United States
(12) Patent Application Publication
(10) Pub. No.: US 2007/0041352 A1
(43) Pub. Date: Feb. 22, 2007

(54) Elevator calling mechanism and method

(76) Inventors: James Lowell Frankel, Lexington, MA (US); James J. Curran JR., Holbrook, MA (US)

Correspondence Address: Patent Department;Mitsubishi Electric Research Laboratories, Inc., 201 Broadway, Cambridge, MA, 02139, US

(21) Appl. No.: 11/206,442

(22) Filed: Aug. 18, 2005

(51) Int. Cl. H04Q 7/24

(52) U.S. Cl. 370/338; 370/401

(57) ABSTRACT

A system calls elevator cars using a wireless network of nodes. A mobile node at an unknown location broadcasts a request packet. The request packet includes an identification of the mobile node and an elevator call command. One or more fixed nodes at known locations measure a signal strength of the received request packet and determine a known location of the mobile node based on the signal strength and the known locations of the fixed nodes, and call an elevator car according to the known location of the mobile node and the elevator call command.

### FIELD OF THE INVENTION

The invention relates generally to wireless ad hoc networks, and more particularly to locating nodes in such networks.

### BACKGROUND OF THE INVENTION

Wireless communications networks and wireless nodes (transceivers) are becoming smaller and smaller. For example, in piconets, the radio range of Bluetooth nodes is ten meters or less. Typically, the nodes in an ad hoc wireless network operate without any centralized infrastructure. Nodes enter and exit the network at will, and the network topology is ad hoc.

Another example is a wireless sensor network. Sensor networks are also used to monitor factory operation, vehicle operation, the environment, and public structures such as bridges and tunnels. Recently, the University of California, Berkeley and Intel Berkeley Research Laboratory demonstrated a self-organizing wireless sensor network including over 800 low-power sensor nodes, each the size of a coin, dispersed over the university campus.

When the nodes are mobile, it is important to know the location of the nodes so that the sensed data can be correlated to specific places.

A number of techniques are known for determining locations of wireless communication nodes in a network such as cellular telephone networks, global and local positioning systems (GPS and LPS), and ad hoc local networks.

Time of Arrival (TOA): This method uses trilateration to determine positions of mobile nodes. Position estimation by trilateration is based on knowing distances from the mobile node to at least three known locations, e.g., base stations or satellites. To obtain accurate timing from which the distances can be computed, the mobile node has to communicate directly with the base station, and exact timing information is also required at all nodes.

However, the radio range of transceivers of many wireless sensor nodes is very short, e.g., less than ten meters. Therefore, to be able to use TOA, the density of the base stations must be high, or timing information must be measured very accurately with synchronized clocks.

Time difference of arrival (TDOA): In this method, time delay estimations are used to determine a time difference of arrival of acknowledgement signals from mobile nodes to the base stations. The TDOA estimates are used to determine range difference measurements between base stations. By solving non-linear hyperbolic functions, estimates of location can be obtained.

Location estimation methods for cellular telephone networks are described by P. C. Chen, “A non-line of sight error mitigation algorithm in location estimation,” IEEE Wireless Communications and Networking Conference,” pp. 316-320, September 1999; J. H. Reed, K. J. Krizman, B. D. Woerner, T. S. Rappaport, “An overview of the challenges and progress in meeting the E-911 requirement for location service,” IEEE Communications Magazine, pp. 30-37, April 1998; and M. A. Spirito, “On the accuracy of cellular mobile station location estimation,” IEEE Trans. Vehicular Technology, vol. 50, no. 3, pp. 674-685, May 2001.

Local positioning systems are described by A. Ward, A. H. A. Jones, “A new location technique for the active office,” IEEE Personal Communications, vol. 4, no. 5, pp. 42-47, October 1997; and J. Werb, C. Lanzl, “Designing a positioning system for finding things and people indoors,” IEEE Spectrum, vol. 35, no. 9, pp. 71-78, September 1998. Local positioning systems can use TOA, TDOA, and RSS, as described below.

What distinguishes location estimation in local area networks from location estimation in large networks are the very short radio ranges and lack of synchronization.

One solution is to provide some of the sensor nodes with location coordinates, see, Patwari, et al., “Relative Location Estimation in Wireless Sensor Networks,” to appear in IEEE Trans. Signal Processing, 2003. They have the sensors estimate ranges between neighboring nodes. With TOA and RSS, they can estimate sensor locations with about 1.5 meter accuracy by averaging RSS measurements over frequency to reduce frequency selective fading error.

Another solution relies on TDOA measurements derived from signals received from at least three transmitters, Gustafsson, et al., “Positioning Using Time Difference of Arrival Measurements,” ICASSP, Hong Kong, PRC, 2003. They use a non-linear least squares fit approach, which enables local analysis yielding a position covariance and a Cramer-Rao lower bound. However, they require a globally synchronized network.

Phase Difference: Another technique measures a phase difference between a stable reference signal and a wireless mobile signal at several known locations. The location of the wireless mobile node is then determined from the phase difference information, see U.S. Patent Application Publication No. 2002/0180640, “Location estimation in narrow bandwidth wireless communication systems,” by Gilkes, et al., Dec. 5, 2002.

In their approach, the mobile nodes embed 1 MHz pilot signals into request messages for obtaining a position fix. Each message also carries a unique node identification and sequence number. A fixed reference station transmits a reference pilot signal. Other stationary nodes in the network measure a phase difference between the pilot signal in the request message and the reference pilot signal. The header information is processed at the reference station to track location of the mobile node. Their approach requires so-called “equipped location marker” nodes to be synchronized with the reference station, e.g., a Bluetooth master node, and among themselves, e.g., Bluetooth slave nodes.

Bluetooth communications systems provide synchronized time slot sharing. Otherwise, message arrivals include offset values. These offset values induce error in relative time of arrival. Therefore, that system is not applicable to sensor networks lacking synchronization. Also, their method induces high computational complexity in Bluetooth equipped location marker nodes, minimally a phase comparator and a phase difference and averaging circuit.

Received Signal Strength (RSS): Here, the mobile node applies trilateration to signal strength measurements obtained from signals received from at least three stationary position nodes. Location estimates based on RSS are often coarse due to environmental factors such as multi-path and shadowing. One signal strength based method is described in U.S. Pat. No. 6,885,969 issued to Sahinoglu on Apr. 26, 2005, “Location estimation in partially synchronized networks.” The problem with RSS methods is that the signal strength can vary due to movement, phasing effects, reflections and physical obstructions.

A radio transmitter can be used to call an elevator car, see U.S. Pat. No. 6,397,976, “Automatic elevator destination call processing,” Hale, et al., Jun. 4, 2002. In that system, the user must explicitly provide a destination. The system does not determine the location of the user. The system described in U.S. Pat. No. 6,109,396, “Remote elevator call placement with provisional call verification,” Sirag, et al., Aug. 29, 2000, also allows a user to call a car. However, in that system, the user must place the call, and the call must be verified when the user is near the elevator shaft and in the car. Similar systems are described in U.S. Pat. Nos. 5,984,051, “Remote elevator call requests with descriptor tags,” Morgan, et al., Nov. 16, 1999; and 5,952,626, “Individual elevator call changing,” Zaharia, Sep. 14, 1999.

U.S. Pat. No. 4,673,911, “Elevator remote-control apparatus,” Yoshida, Jun. 16, 1987, describes a remote controller to enter an elevator ‘up’ or ‘down’ call. The call is transmitted directly to a hall call button device. That system requires that the user be in close proximity to the elevator call button device. The actual location of the user is unknown.

### SUMMARY OF THE INVENTION

The invention operates in an ad hoc network of nodes. In the ad hoc network, the nodes autonomously determine a topology of the network. The network includes mobile nodes at unknown locations and fixed nodes at known locations. The nodes include radio transceivers for communicating with each other. The fixed nodes can also communicate with each other via a wired network.

One embodiment of the invention determines locations of mobile nodes in an ad hoc network. Each node includes a radio transceiver. The locations can be used by building automation, security, material tracking, and remote signaling applications.

The fixed nodes can communicate with a root node. The root node can determine the location of a mobile node when several fixed nodes receive data packets from the mobile node. The fixed nodes forward the packets to the root node. The packets identify the mobile node and a signal strength of the received signal. The signal strength is proportional to a distance between the nodes. When three or more fixed nodes receive the same packet, trilateration can be used to locate the mobile node.

### BRIEF DESCRIPTION OF THE DRAWINGS

FIG. 1 is a block diagram of an ad hoc network according to one embodiment of the invention;

FIG. 2 is a block diagram of a mobile node according to one embodiment of the invention;

FIG. 3 is a block diagram of a data packet according to one embodiment of the invention;

FIG. 4 is a diagram of trilateriation-based distance measuring according to an embodiment of the invention; and

FIG. 5 is an example floor plan according to one embodiment of the invention.

### DETAILED DESCRIPTION OF THE PREFERRED EMBODIMENT

### Network Configuration

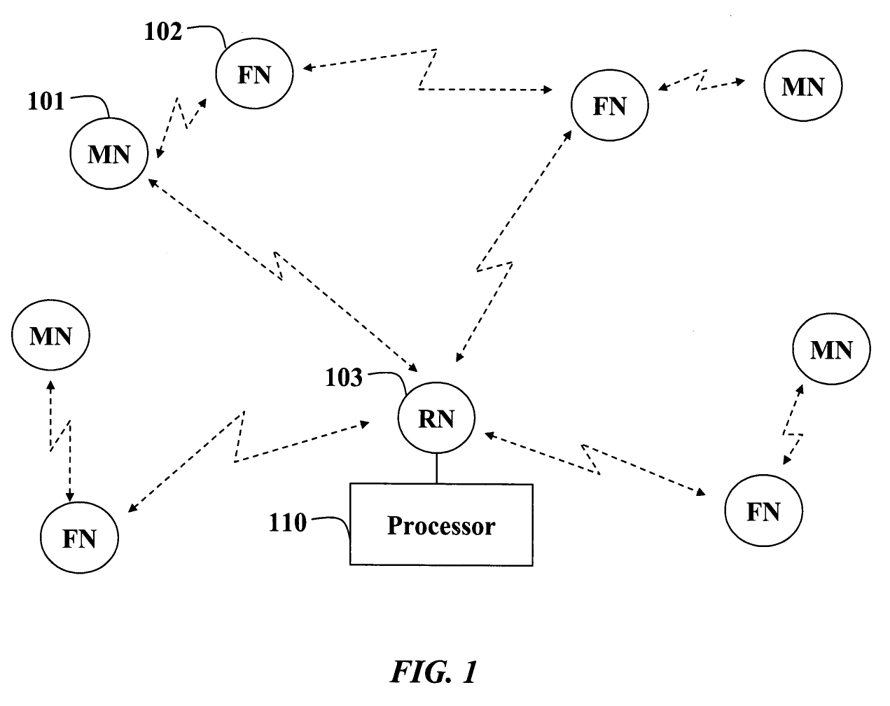

FIG. 1 shows an ad hoc network 100 according to one embodiment of the invention. In the ad hoc network, transceiver nodes autonomously determine a topology of the network. The network includes mobile nodes (MN) 101 at unknown locations and fixed nodes (FN) 102 at known locations. The network also includes a root node (RN) 103 connected to a processor 110. Each node includes radio transceivers for communicating with other nodes. In one embodiment, the transceiver is the same is used in the U.C. Berkeley sensor network, described above. The fixed nodes 102 can also communicate with each other via a wired network. The RN 103 communicates with a processor 110, which performs a method for determining the locations of the mobile nodes 101. Each node can also include a microprocessor.

### Mobile Node and Elevator

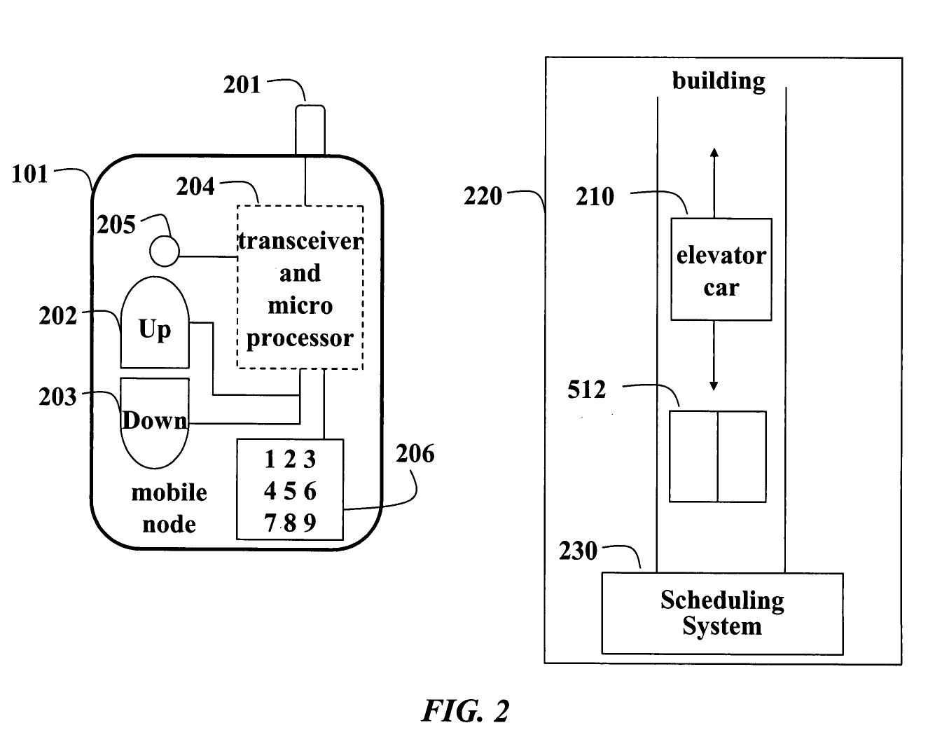

FIG. 2 shows one embodiment of a mobile node 101. The mobile node includes an antenna 201, an up button 202, a down button 203, and a microprocessor 204. In one example application, a user of the MN can request an elevator car 210 in a building 220 by pressing either the up button 202 or the down button 203 to indicate a direction to be taken by the car. An indicator light 205 can signal an acknowledgement of the request. The mobile node can also include a keypad 206 for entering a destination floor.

Most buildings with a large number of elevator shafts include a scheduling system 230. In this case, the root node can forward elevator requests to the system 230.

Because the location of the mobile node can be determined, it is also possible to determine the distance the user needs to travel to an elevator hall 512. This travel distance can be used to coordinate and schedule the arrival time of the elevator car.

### Elevator Request Packet

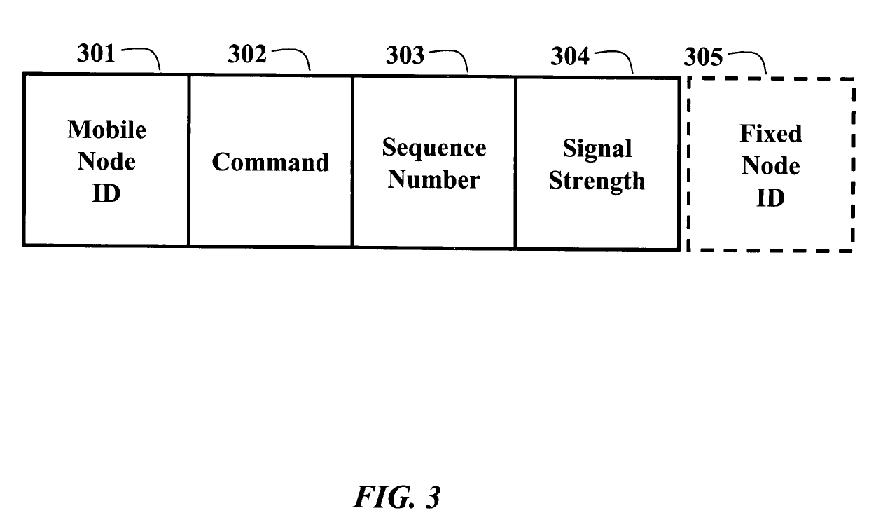

FIG. 3 shows a request (REQ) packet 300 broadcasted by the MN when one of the buttons is pushed. The request packet includes a mobile node identification (ID) 301, a elevator call command (up/down) field 302, a packet sequence number field 303, and a signal strength field 304. The command field can also store the destination floor.

The packet is broadcasted repeatedly until the MN receives an acknowledgment (ACK) packet from one or more of the fixed nodes that the packet 300 has been received and processed, or after a time-out interval expires. To increase reliability, the packet can be broadcast at least a minimum number of times, e.g., 32 times.

The fixed nodes receiving the packet insert the signal strength of the received signal in the field 304. If the packet is received multiple times by one fixed node, then the signal strength can be based on an average. Each fixed node also inserts its identification 305 in the packet, see FIG. 3. The packet is then forwarded to the root node.

It should be noted that the fixed nodes can periodically broadcast a ranging signal. In this case, the mobile nodes can measure the signal strength to be inserted in the REQ packet.

From the fixed node ID, the root node can determine the location of the fixed node. Furthermore, the root node can determine the distance between the fixed node and the mobile node from the signal strength. This distance can be converted to a location using trilateration. Of course, the accuracy of the location increases according to the number of fixed nodes that received the request packet.

### Trilateration

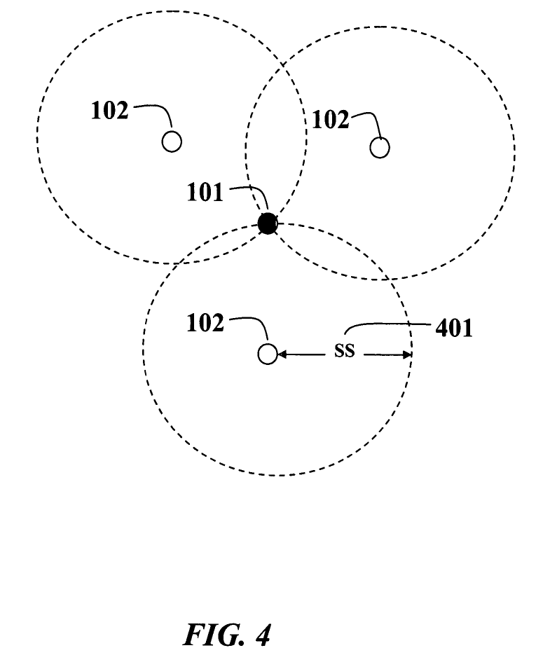

As shown in FIG. 4, each FN 102 that receives the packet determines a signal strength 401 of the received signal associated with the packet. The signal strength is used to determine the distance between the MN 101 and the one or more FN 102 using trilateration. The distance calculation is based on a method described by Savarese, et al., “Robust Positioning Algorithms for Distributed Ad hoc Wireless Sensor Networks,” Proceedings of the General Track: 2002 USENIX Annual Technical Conference, June 2002, incorporated herein by reference. Another method is described in U.S. Pat. No. 6,885,969, incorporated herein by reference. At least three fixed nodes should receive the request packet to make a reasonable location estimate.

### Distances

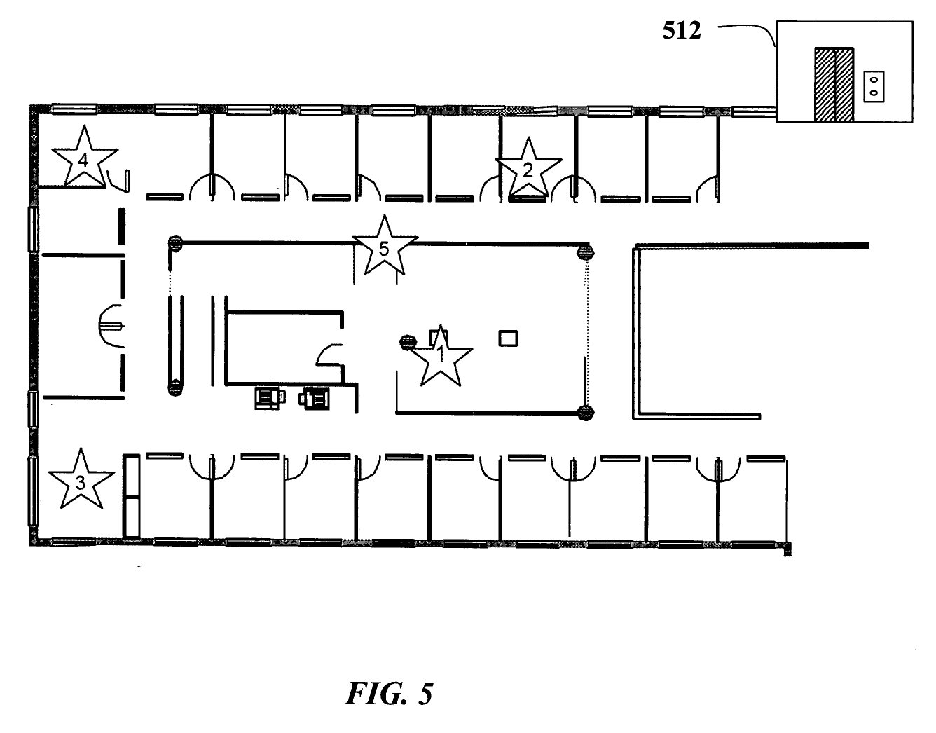

It should be noted that the distance that the user needs to travel to reach the elevator hall 512 may not necessarily be a straight line. Therefore, the system can store one or mare floor plans as shown in FIG. 5 to determine the travel distance from various locations 1-5.

### Probability Distribution of Arrival Time

Rather than just predicting a single arrival time at the elevator hall, it is possible to generate a probability distribution of arrival times based on an uncertainty or error distribution of the location of the mobile node at the time an elevator request is generated. The probability distribution can include a variety of possible paths from the location of the user, speed of travel, time of day, and so on.

It is also possible to consider the arrival time of multiple passengers in multiple halls during the scheduling of elevator calls by the system 230.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for calling an elevator car using a wireless network of nodes, comprising the steps of:
broadcasting a request packet from a mobile node at an unknown location, the request packet including an identification of the mobile node and a elevator call command;
receiving, in a set of fixed nodes, the request packet, each fixed node having a known location;
measuring a signal strength associated with the request packet in each fixed node;
inserting the signal strength and an identification of the fixed node in the request packet received at each fixed node;
forwarding the request packet from each fixed node to a root node;
determining, at the root node, a known location of the mobile node from the signal strength and the known locations of the set of fixed nodes; and
calling an elevator car according to the known location of the mobile node and the elevator call command.

2. The method of claim 1, in which the elevator call command is up or down.

3. The method of claim 1, in which the elevator call command includes a destination floor.

4. The method of claim 1, further comprising:
broadcasting repeatedly the request packet until the mobile node receives an acknowledgment packet from at least one of the set of fixed nodes.

5. The method of claim 4, further comprising:
averaging the signal strength from multiple received request packets.

6. The method of claim 1, in which the determining uses trilateration.

7. The method of claim 1, in which the calling depends on a travel time from the known location of the mobile node and an elevator hall.

8. The method of claim 7, the travel time is expressed as a probability distribution.

9. The method of claim 7, in which the travel time is determined using a floor plan.

10. The method of claim 7, in which the travel time depends on a speed of a user of the mobile node.

11. The method of claim 1, in which multiple request packets are broadcast concurrently by multiple mobile nodes, and elevator cars are scheduled according to the locations of the multiple mobile nodes.

12. A method for calling an elevator car using a wireless network, comprising the steps of:
broadcasting a signal requesting an elevator call from a mobile transmitter carried by a user at an unknown location;
measuring a signal strength associated with the signal in a set of receivers at known locations;
determining a known location of the user from the signal strength and the known locations of the receivers, and
calling an elevator car according to the known location of the user.

13. A system for calling an elevator car using a wireless network of nodes, comprising:
a mobile node at an unknown location, the mobile node configured to broadcast a request packet, the request packet including an identification of the mobile node and a elevator call command;
a set of fixed nodes at known locations, each fixed node configured to measure a signal strength of a received request packet;
means for determining a known location of the mobile node based on the signal strength and the known locations of the fixed nodes; and
calling an elevator car according to the known location of the mobile node and the elevator call command.
